(19) United States
(12) Patent Application Publication
(10) Pub. No.: US 2008/0248882 A1
(43) Pub. Date: Oct. 9, 2008

(54) VIDEO GAME CONSOLE ADAPTER

(76) Inventor: Kent T. J. Hsu, Taipei (TW)

Correspondence Address: SAM CHEN, 7F-1, 293, ROOSEVELT ROAD, SEC 3, TAIPEI, TW

(21) Appl. No.: 11/695,603

(22) Filed: Apr. 3, 2007

(51) Int. Cl. A63F 13/02

(52) U.S. Cl. 463/47

(57) ABSTRACT

An adapter in one embodiment includes a conversion circuit, a first connector adapted to connect to a port of a PS3, a second connector adapted to connect to a PS2 controller, and a port adapted to connect to a removable memory card for PS2. The conversion circuit is adapted to convert a PS2 signal sent from the connected PS2 controller into a PS3 signal prior to sending to the connected PS3, and convert a PS2 data signal sent from the connected memory card into a PS3 data signal prior to sending to the connected PS3. Alternatively, the adapter and the PS2 controller are connected by wireless.

### BACKGROUND OF THE INVENTION

1. Field of Invention

The invention relates to video game console adapters and more particularly to an adapter adapted to interconnect a video game console (e.g., PS3 (PlayStation 3)) and a controller (e.g., PS2 (PlayStation 2) controller) such that a person may operate the PS2 controller to use the PS3 for playing.

2. Description of Related Art

A wide variety of video game consoles are available on an even faster pace. It is typical of being impossible of using a controller of an old type video game console to operate a new type video game console produced by the same company. It is also typical of being impossible of using a memory card of an old type video game console in a new type video game console produced by the same company. It is further typical of being impossible of using peripherals of an old type video game console on a new type video game console produced by the same company. This means that a person has to buy not only a new type video game console but also peripherals thereof. Thereafter, the person can use the new type of video game console. It is not economical.

Therefore, a variety of adapters for video game console peripherals are commercially available. For example, there is an adapter for video game console controller on the market. A video game console controller mounted with the adapter is capable of operating a new type of video game console produced by the same company. Also, there is an adapter for memory card of video game console on the market. A new type of video game console mounted with the adapter is capable of accessing data from an inserted memory card for an old type of video game console produced by the same company.

However, any such conventional type of adapter can only be employed in a specific peripheral of a video game console produced by the same company. In other words, each peripheral has its specific adapter and a person has to buy the adapter in addition to the peripheral. It is still not economical. Thus, the need for improvement still exists.

### SUMMARY OF THE INVENTION

It is therefore one object of the invention to provide an adapter interconnecting a video game console (e.g., PS3) and a controller (e.g., PS2 controller) such that a person may operate the PS2 controller to use the PS3 for playing.

The above and other objects, features and advantages of the invention will become apparent from the following detailed description taken with the accompanying drawings.

### BRIEF DESCRIPTION OF THE DRAWINGS

FIG. 1 is an exploded perspective view of a video game console adapter according to the invention;

FIG. 2 is a perspective view of a video game console (e.g., PS3) and a video game console controller (e.g., PS2 controller) interconnected by the adapter;

FIG. 3 is a block diagram of the adapter, the video game console, the video game console controller, and the memory card;

FIG. 4 depicts a wired interconnection of the second connector and the video game console controller of a first configuration; and

FIG. 5 depicts a wireless interconnection of the adapter and the video game console controller of a second configuration.

### DETAILED DESCRIPTION OF THE INVENTION

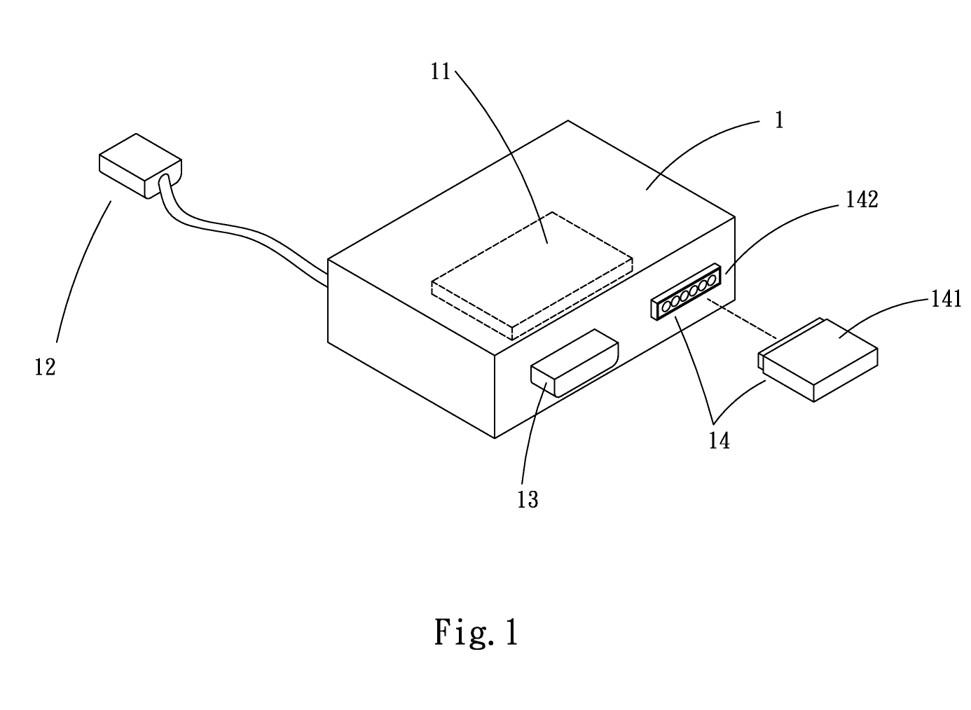

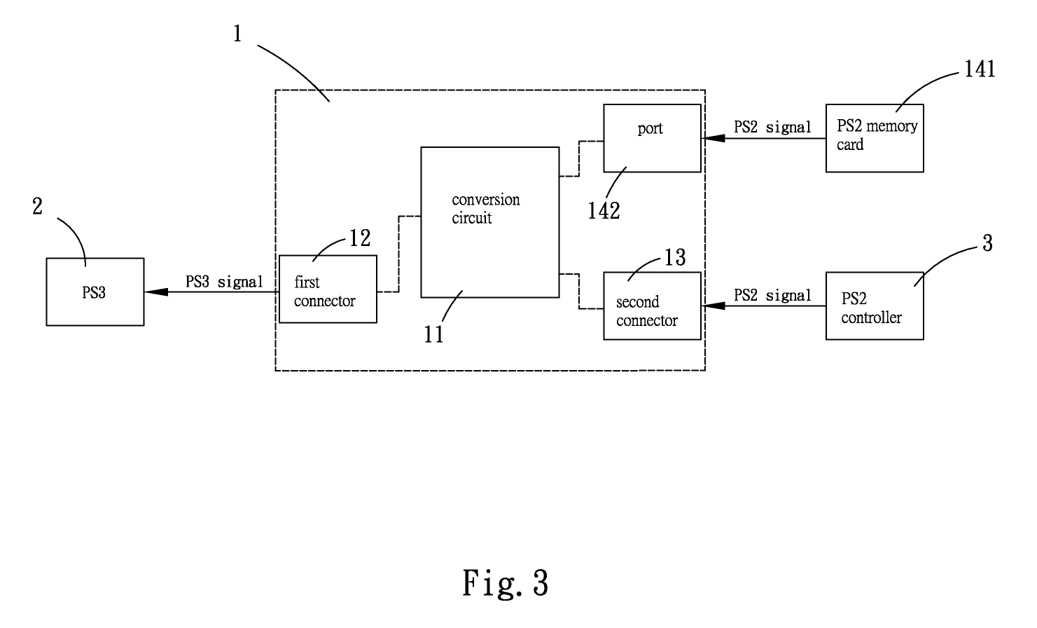

Referring to FIGS. 1 to 3, an adapter 1 of a preferred embodiment of the invention is shown. The adapter 1 is adapted to interconnect a video game console (e.g., PS3) 2 and a video game console controller (e.g., PS2 controller) 3. Note that, both PS3 and PS2 are produced by SONY.

The adapter 1 comprises a conversion circuit 11, a front wired first connector 12 adapted to connect to a port of the PS3 2, a rear second connector 13 adapted to connect to the PS2 controller 3, and a rear memory card assembly 14 including a removable memory card 141 and a port 142 adapted to connect to the memory card 141.

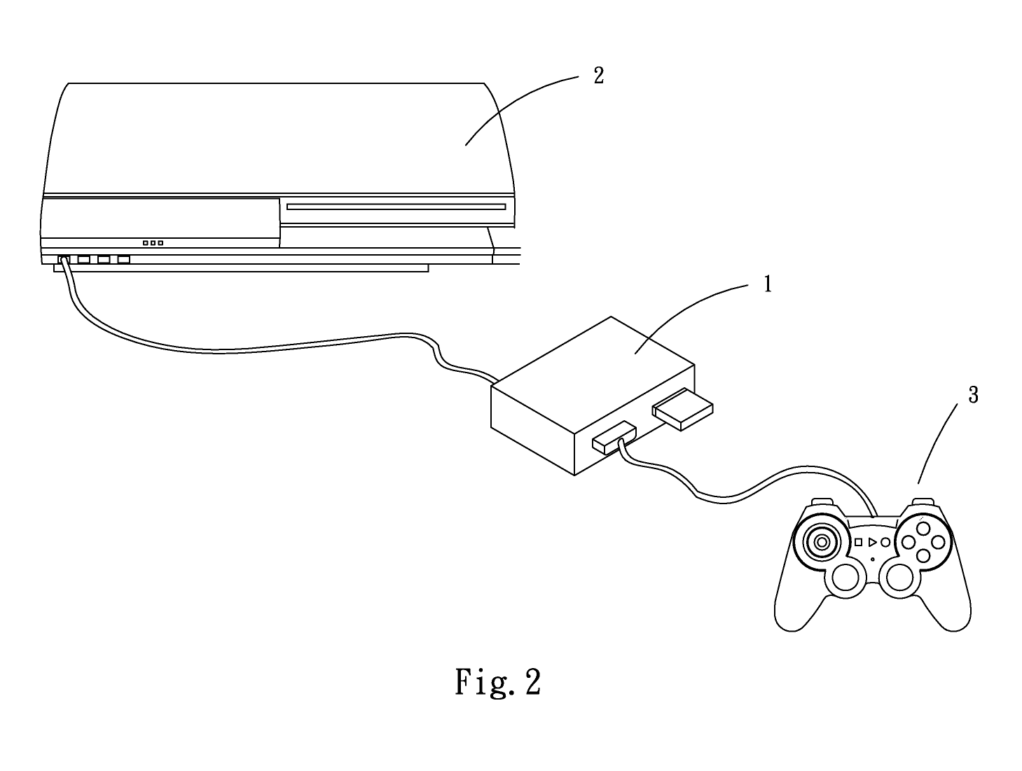

The conversion circuit 11 is adapted to convert PS2 signals sent from the PS2 controller 3 into PS3 signals which are in turn sent to the PS3 2 after interconnecting the PS2 controller 3 and the PS3 2 as shown in FIG. 2. Thereafter, a person may operate the PS2 controller 3 to use the PS3 2 for playing.

The memory card 141 is a memory card originally designed for PS2. Advantageously, the conversion circuit 11 is adapted to convert PS2 data signals sent from the inserted memory card 141 into PS3 data signals which are in turn sent to the PS3 2. That is, the PS3 2 can access data stored in the memory card 141. In short, a memory card for PS2 can be used in PS3.

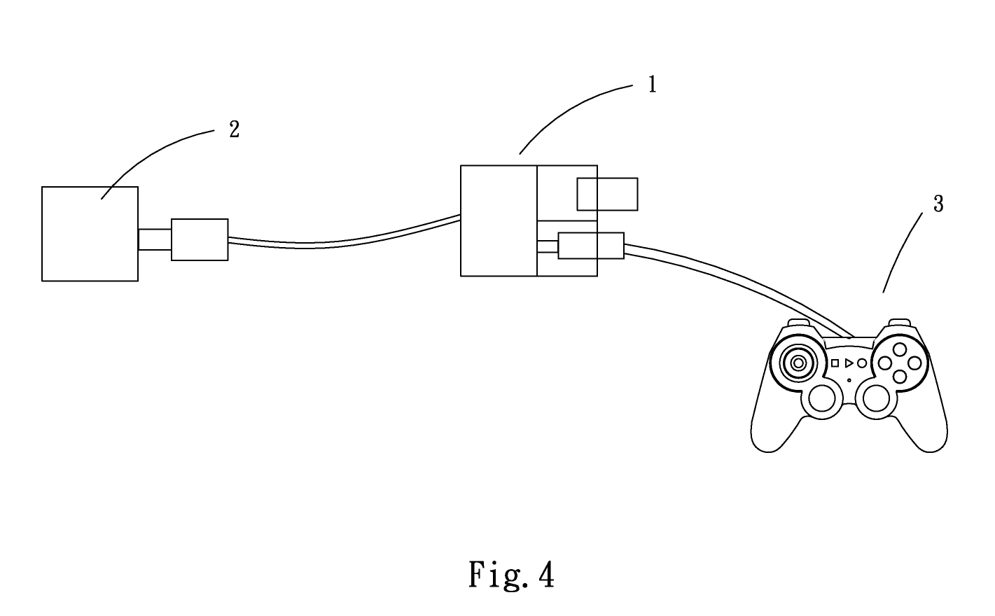

Referring to FIG. 4, a wired interconnection of the adapter 1 and the PS2 controller 3 of a first configuration is shown.

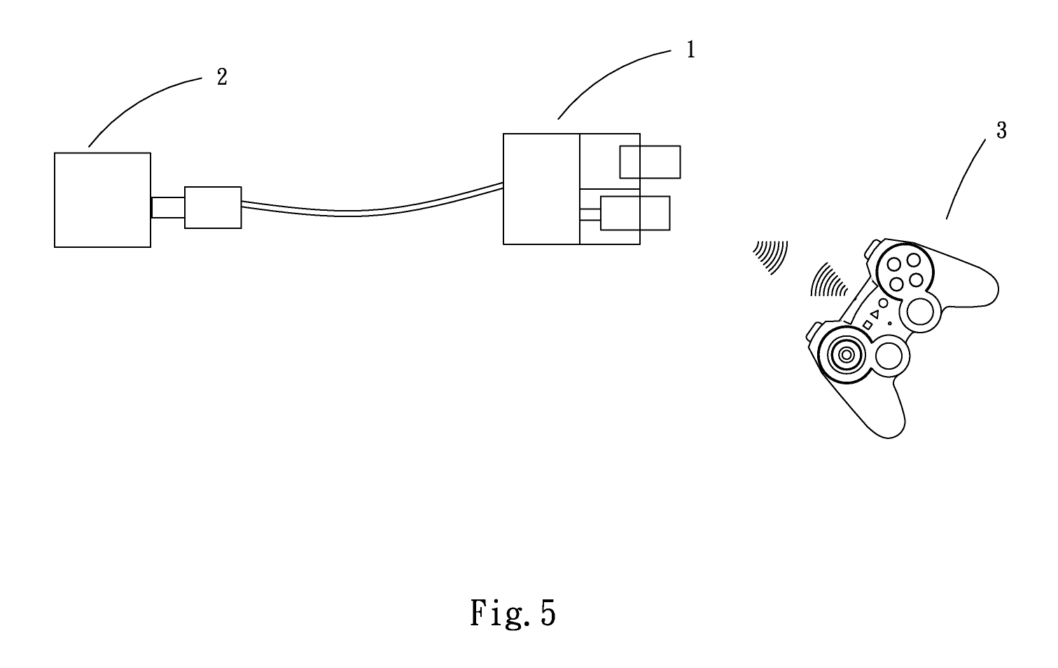

Referring to FIG. 5, a wireless interconnection of the adapter 1 and the PS2 controller 3 of a second configuration is shown.

While the invention herein disclosed has been described by means of specific embodiments, numerous modifications and variations could be made thereto by those skilled in the art without departing from the scope and spirit of the invention set forth in the claims.

What is claimed is:

1. An adapter comprising:
a conversion circuit;
first means for connecting to a port of a PS3 (PlayStation 3);
second means for connecting to a PS2 (PlayStation 2) controller; and
a port adapted to connect to a removable memory card for PS2,
wherein the conversion circuit is adapted to:
convert a PS2 signal sent from the connected PS2 controller into a PS3 signal prior to sending to the connected PS3; and
convert a PS2 data signal sent from the connected memory card into a PS3 data signal prior to sending to the connected PS3.

2. The adapter of claim 1, wherein the second connection means and the PS2 controller are connected by wire.

3. The adapter of claim 1, wherein the second connection means and the PS2 controller are connected by wireless.
